(19) United States
(12) Patent Application Publication
(10) Pub. No.: US 2002/0071594 A1
(43) Pub. Date: Jun. 13, 2002

(54) LS tracker system

(76) Inventors: Allen Kool, London (CA); Doug Leverton, Bowser (CA)

Correspondence Address: Richard J. Parr-Regn, Bereskin & Parr, Box 401, 40 King Street West, Toronto, ON, M5H 3Y2, CA

(21) Appl. No.: 09/972,856

(22) Filed: Oct. 10, 2001

Related U.S. Application Data
(60) Provisional application No. 60/239,260, filed on Oct. 12, 2000.

(51) Int. Cl. G06K 9/00

(52) U.S. Cl. 382/103

(57) ABSTRACT

An image tracking apparatus for tracking the movement of an image of a moving object or target within a broadcast image. The apparatus comprises an optical identifier device which attaches to the moving object and generates an optical identification signal, where an image capture system receives the image of the moving object and the optical identification signal, and generates a coordinate position value for the image of the moving object within each image frame. The coordinate position value coincides with the location of the optical identifier device on the moving object or target.

### PRIOR APPPLICATION

This application claims the benefit of U.S. Provisional Application Ser. No. 60/239,260, filed Oct. 12, 2000 entitled “LS TRACKER SYSTEM”.

### FIELD OF THE INVENTION

The present invention relates to an image tracking system used within broadcasting. More particularly, it relates to an apparatus which enables the tracking of images of moving objects or targets, and to a method of tracking such images.

### BACKGROUND OF THE INVENTION

Filming and monitoring various images, events and scenes has lead to a great many advances and inventive leaps in image processing, camera technology and automation in capturing images of moving objects or events of interest. Increased microprocessor speeds have played a major role in advancing the quality and capabilities of film and image processing used in the broadcast industry.

Broadcast events usually require coverage of events incorporating moving objects within sporting events, wildlife documentaries or surveillance. As a result of this, various image tracking and processing systems have been developed in order to capture and track the movement of images relating to these moving objects. Furthermore electronic devices have been developed for inserting images into live video signals or broadcast image frames, such as those described in U.S. Pat. No. 5,264,933.

U.S. Pat. No. 6,100,925 describes a Live Video Insertion System (LVIS) that allows the insertion of static or dynamic images into a live video broadcast on a real time basis. The LVIS uses a combination of pattern recognition techniques and camera sensor data (e.g. pan, tilt, zoom, etc.) to locate, verify and track target data.

U.S. Pat. No. 5,706,362 describes an image tracking apparatus which selects the image of the target vehicle to be tracked, and stores this image in a reference image memory. The reference image and subsequent images are subjected to comparisons in order to determine changes between them as a result of the target vehicle position changing within each of the stored images.

Accordingly, there is a need for an image tracking method and apparatus capable of tracking the image of a moving object within broadcast image frames without the computation overhead required for processing and scanning image frames in order to determine the object or targets position in each frame. Furthermore, the provision of smooth tracking of a target image within broadcast frames provides a natural viewing perception of graphic images inserted into the broadcast frames for tracking the target (e.g. information balloons).

### SUMMARY OF THE INVENTION

The present invention relates to an image tracking apparatus for tracking the movement of an image of a corresponding moving object. In one aspect the apparatus comprises: an optical identifier device which attaches to the moving object and generates an optical identification signal; and an image capture system for receiving the image of the moving object and the optical identification signal, and generating a coordinate position value related to the image of the moving object.

In accordance with another aspect of the present invention, a method of tracking the movement of an image of a corresponding moving object is determined by: generating an optical identification signal at the moving object, as the moving object moves; and receiving an image of the moving object and the optical identification signal, and generating a coordinate position value related to the image of the moving object.

### DETAILED DESCRIPTION OF THE DRAWINGS

For a better understanding of the present invention and to show how it may be carried into effect, reference will now be made to the following drawings which show the preferred embodiment of the present invention, in which:

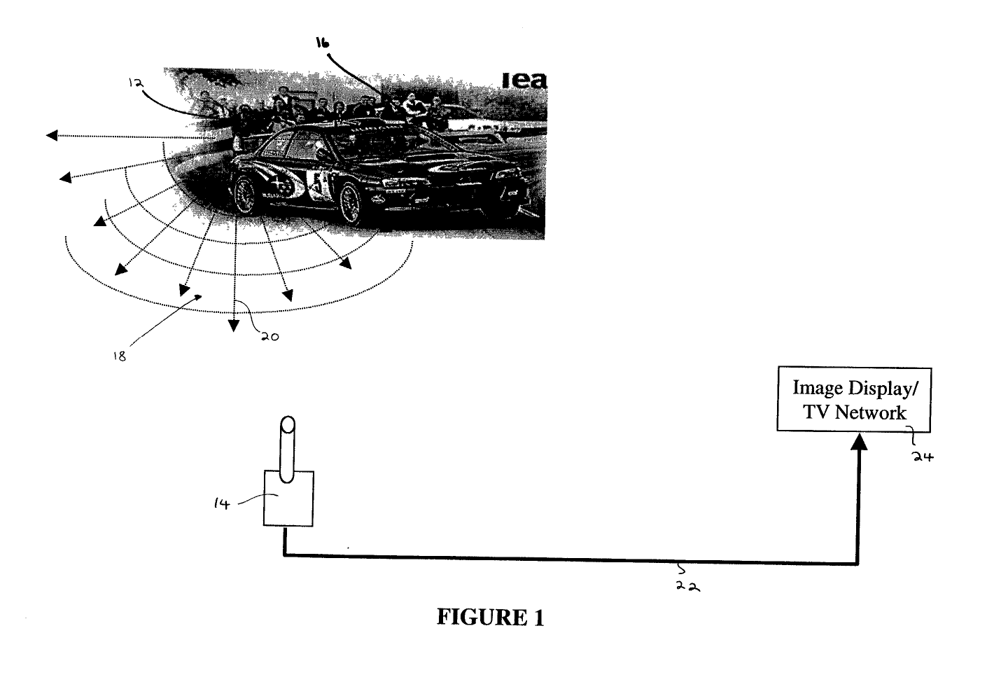

FIG. 1 illustrates a system level diagram of an image tracking apparatus of the invention in use;

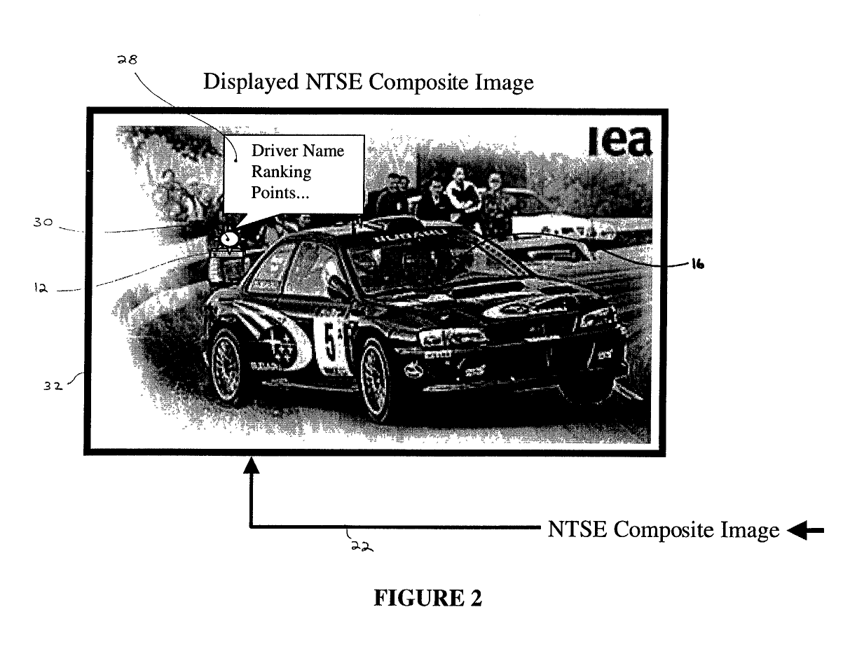

FIG. 2 illustrates a functional display produced by the image tracking apparatus shown in FIG. 1;

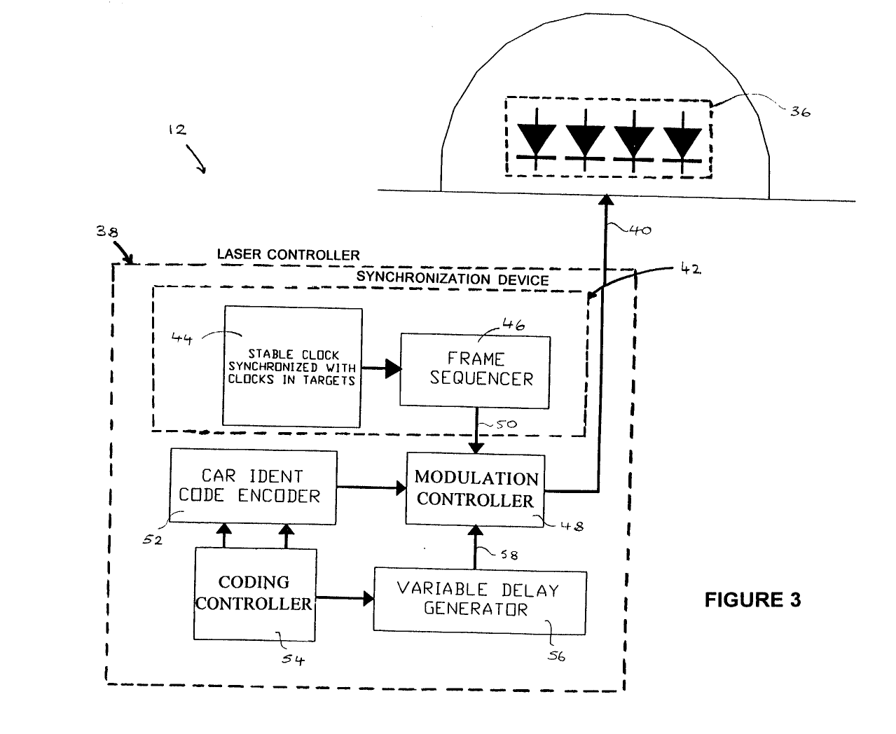

FIG. 3 illustrates a block diagram of an object identifier device incorporated within the image tracking apparatus of FIG. 1;

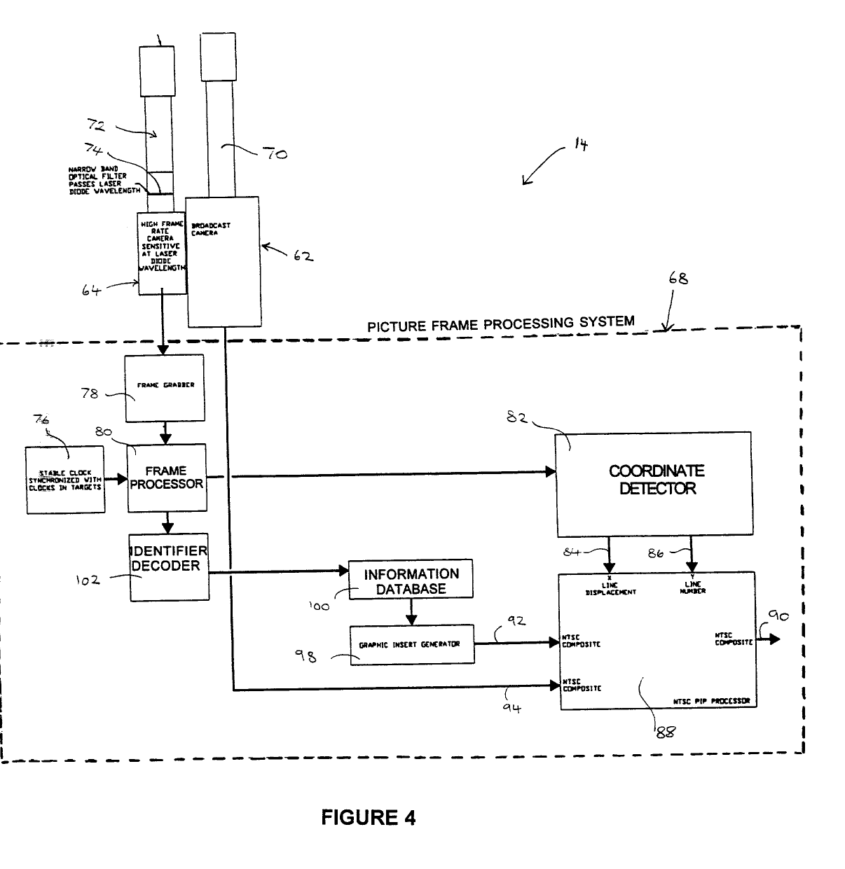

FIG. 4 illustrates a block diagram of an image capture system comprising a two lens imaging system, which is incorporated within the image tracking apparatus of FIG. 1;

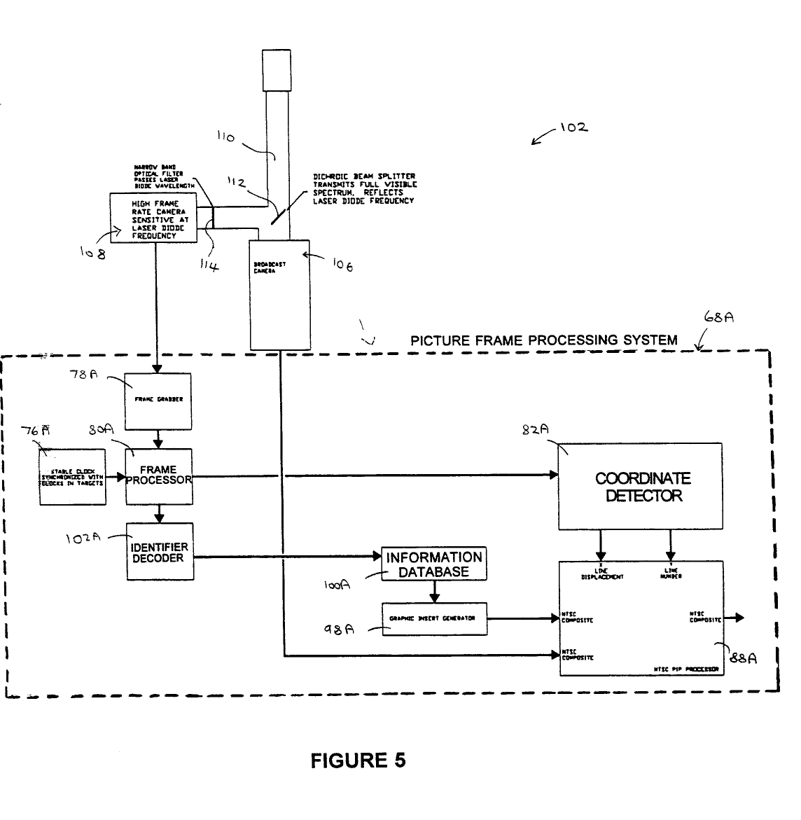

FIG. 5 illustrates an block diagram of an image capture system comprising a single lens imaging system, which is incorporated within the image tracking apparatus of FIG. 1; and

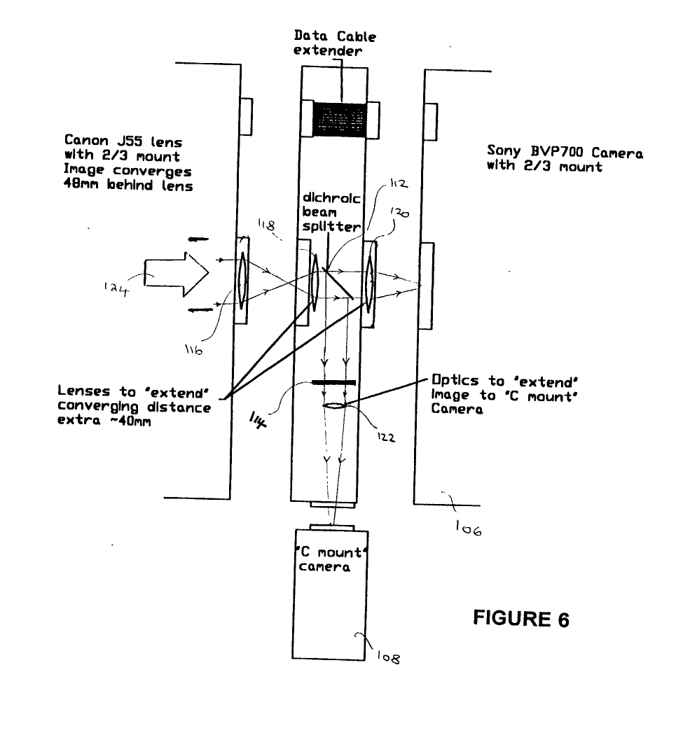

FIG. 6 illustrates the optical system within the single lens imaging system of FIG. 5.

### DETAILED DESCRIPTION OF THE PREFERRED EMBODIMENT

FIG. 1 illustrates the operating principle of an image tracking apparatus. The image tracking apparatus comprises an optical identifier device 12 and an image capture system 14. The optical identifier device 12 is attached to a moving object 16 such as a racing car, so that the optical identifier emits an optical identification signal over a 180° radius, as indicated at 18. The wide optical emission area, indicated at 18, ensures that the optical identification signal is received with the image of the moving object by the camera system, particularly when the camera system pans and zoom to follow the moving object 16 as it passes. The 180° emission area, indicated at 18, of the optical identification signal is generated by a group of laser devices, wherein each laser device generates an optical output, as indicated at 20, representing a portion of the total optical emission area, as indicated at 18.

The image capture system 14 includes a camera system and a picture frame processing system for receiving and processing the image of the moving object and the optical identification signal. The camera system 14 sees the optical identification signal as a point source of bright light, and depending on the angle of the moving object 16 with respect to the camera system 14 (during panning), at least one of the plurality of laser devices generates an optical output which is detected as a point source of light by the camera system 14.

The camera system 14 generates a series of image frames corresponding to the image of the moving object 16 and the optical identification signal, and the picture frame processing system provides a succession of image processing steps on these frames. Following the image processing, the picture frame processing system generates a coordinate position value for the point source of light generated by optical identification signal emitted from the optical identifier device 12. Consequently, the coordinate position value corresponds to a point on the image of the moving object 16 where the optical identifier device 12 is attached. The coordinate position value and image frames corresponding to the image of the moving object 16 are sent via a communication medium (e.g. coaxial cable, infrared, rf, etc.) or a communications link (e.g. satellite link), as indicated by 22, to a TV broadcast network or broadcast cable company, as indicated at 24 for image display coverage.

FIG. 2 illustrates the image display coverage for the moving object 16. The broadcast image of the moving object 16 is received from the communication medium or link, indicated by 22, as an NTSC composite image comprising an information graphic image 28. The picture frame processing system superimposes the information graphic image 28 on the image frames corresponding to the image of the moving object 16, whereby the thumb nail graphic 28 is inserted at the coordinate position value, as defined by 30. As indicated above, this coordinate position value, defined by 30, is in close proximity to the optical identifier device 12 due to the emission of the optical identification signal from the optical identifier device 12, which is processed by the image capture system 14 (FIG. 1) . Within each NTSC frame period ( ˜16 ms), the picture frame processing system determines an updated value of the coordinate position value, indicated at 30, based on the new location of the object image 16 within each of the series of image frames 32. Therefore, as the image of the object moves within the image frames so does the graphic image 28, such that the graphic image 28 follows the image of the object 16.

The information inserted within the graphic image 28 is determined by a coding scheme incorporated within the picture frame processing system and optical identifier device 12. Therefore, each moving object having an attached optical identifier device 12 is identified by a unique identifier code, which is modulated onto the optical identification signal by its corresponding optical identifier device 12. In the example shown in FIG. 2, the information inserted into the graphic image 28 refers to statistics and information relating to the driver of the car (moving object image 16). The picture processor system decodes the received optical identification signal and determines what information to insert into the graphic image 28 based on the unique code extracted by the decoder.

FIG. 3 illustrates a block diagram of the optical identifier device 12 comprising a plurality of laser devices 36 and a laser controller 38 for generating an electrical drive signal, indicated by 40, for modulating the plurality of laser devices 36 with the unique identification code. The laser controller 38 includes a synchronization device 42 which includes a stable synchronized system clock 44 and a frame sequencer 46. The laser controller 38 also includes a modulation controller 48 for receiving a timing enable signal, indicated at 50, from the frame sequencer 46 and modulating the plurality of laser devices 36 with the unique identifier code.

The system clock 44 is synchronized to operate in phase with an existing system clock operating within the image capture system 14 (see FIG. 1). As the image tracking apparatus can track several moving objects (for example four moving objects) within a given NTSC frame period (˜16 ms), each moving object having an optical identifier device 12 must have its system clock 44 synchronized with all other system clocks. The synchronization can be achieved by activating each system clock 44 located at each remote object and activating the system clock 44 within the picture processing system simultaneously. The activation or resetting of these clocks can be done wirelessly using rf transmission or infrared transmission. Once the clocks have been activated simultaneously, they operate in phase with one another and stay in phase as a result of the inherent clock stability.

The frame sequencer 46 receives the clock output from the system clock 44 and generates the timing enable signal, indicated at 50, at the start of each ˜4 ms subframe (four subframes in total) within each ˜16 ms NTSC frame. This causes the modulation controller device 48 to optically modulate the plurality of laser devices 36 with the unique code at the start of a ˜4 ms subframe period for a ˜4 ms duration. It will be appreciated that each subframe is a fraction of the NTSC frame period. Consequently, this allows several optical identifier devices to operate within its designated subframe within each NTSC frame.

A car identification code encoder 52 generates the unique identifier code either locally within the optical identifier device 12, or it receives the unique identification code remotely using, for example wireless transmission (e.g. rf or infra red). The unique identification code received through wireless transmission is received by a coding controller 54. The coding controller 54 sends the unique identifier code to the code encoder 52, wherein the code encoder 52 drives the modulation controller 48 with the unique identifier code. The coding controller 54 may also receive a modulation delay value wirelessly, or it may generate the delay value locally within the optical identifier device 12. The modulation delay value is received by a variable delay generator 56, which generates a modulation delay signal, as defined by 58. The modulation delay signal activates the modulation controller 48 (active for ˜4 ms) once every ˜16 ms between each NTSC frame. The modulation controller 48 will be activated for ˜4 ms during the same subframe period within each NTSC frame and turned off for a ˜12 ms delay by the variable delay generator 56 between NTSC frames.

The modulation controller device 48 modulates the lasers 36 with the unique identification code when it receives the timing enable signal, defined by 50, from the frame sequencer 46 and the modulation delay signal, defined by 58, from the variable delay generator 56. Consequently, the laser devices 36 go through a repeated cycle, where they are modulated (active) for ˜4 ms during each NTSC frame and turn off (disabled) for ˜12 ms between each NTSC frame. By dividing the NTSC frame into four subframes, four moving objects can be tracked using the optical identifier device 12. It will be appreciated that by increasing frame processing speeds in broadcast camera technology, the number of allocated subframes and potential tracked moving objects will increase.

If four objects are being tracked for example, each moving object (e.g. race car) will have an object identifier device 12 which is activated (lasers modulated) within one subframe (a different one of four for each object). During the tracking setup, the delay generator 56 in each optical identifier device 12 is assigned a different modulation delay value in order to ensure that each optical identifier device 12 generates the optical identification signal within its own designated ˜4 ms subframe, or in other words is assigned an allocated subframe. Each optical identification signal corresponding to each of the four moving objects can now be processed by the image capture system within each NTSC frame. Once the variable delay generator 56 has provided the subframe allocation for each object, as mentioned above, the modulation controller 48 will be activated for ˜4 ms during each designated object's subframe period within each NTSC frame, and will be turned off for a ˜12 ms delay by the variable delay generator 56 between NTSC frames.

Within each optical identifier device 12, approximately twenty laser devices 36 are arranged in order to generate an optical beam emission with an area of coverage of 180° degrees horizontal by 45° vertical. Therefore, the modulated laser devices 36 generate the optical identification signal for a designated ˜4 ms subframe period within each NTSC frame, wherein the optical emission coverage area of the optical identification signal is 180° degrees horizontal by 45° vertical. As explained in the following paragraphs, the image capture system detects and processes the optical identification signal emitted from each optical identifier device 12 in order to constantly (within each NTSC frame) generate the coordinate position value of a point related to the image of the object. The position location of this point relative to the image of the object is determined by the activated optical identifier device 12 attached to the object. As previously explained, the image capture system sees the optical identification signal emitted from each optical identifier device 12 as a point source of bright light. It is this point source of light that is processed by the image capture system.

FIG. 4 illustrates a block diagram of the image capture system 14 which includes a first camera 62, a second camera 64 and a picture frame processing system 68, wherein the picture frame processing system 68 is responsible for the acquisition and processing of image frames received from the first and second camera 62, 64. The first camera 62 is a broadcast camera used for generating a first series of image frames comprising broadcast quality NTSC image frames of filmed objects (e.g. race cars). The first camera 62 has a first lens 70, which can be a Canon J55.

The second camera 64 is a high frame rate camera (four times NTSC rate) used for generating a second series of image frames which include image frames of the received optical identification signal emitted from each optical identifier device 12 attached to each filmed object. The image frames of the received optical identification signals emitted from each object are received by the picture frame processing system 68 in order to generate a coordinate position value for each point source of light produced on the image frames. Each point source of light on an image frame, identifies the position of the object within that image frame.

The second high frame rate camera device 64 has a second lens 72 which includes a narrow band optical filter 74. The narrow band optical filter 74 receives images of the objects and the optical identification signals emitted from these objects, and generates optically filtered image frames. The filter only passes the wavelengths corresponding to the emitted optical identification signals. Therefore, the optically filtered image frames include only the point sources of light emitted from the objects being filmed by the first and second cameras 62, 64.

The mechanical structure or arrangement of the first and second cameras 62, 64, is such that they are placed side by side to form a single camera system for filming the same event. The difference between the two cameras is that one camera (first camera 62) generates the broadcast quality images of the objects, whilst the other camera (second camera 64) determines the position of the mentioned objects within each of the broadcast quality images.

The picture frame processing system 68 comprises a stable synchronized system clock 76, a frame grabber 78, a frame processor 80 and a unique identifier decoder device 82. The optically filtered image frames corresponding to the optical identification signals are accessed by the frame grabber 78 and presented to the frame processor 80 for eliminating background noise from the optically filtered image frames. There is a probability that solar reflection off other objects may create bright spots within the optically filtered images and that they will be mistakenly processed as an optical identification signal from one of the moving objects being filmed. This is overcome by the frame processor 80 subtracting from each subframe accessed by the frame grabber 78, the preceding adjacent subframe. The difference frame generated as a result of this subtraction is processed by determining which pixels within the difference frame have a saturation value below two hundred (saturation value at each pixel ranges between 0-255) and discarding them by applying a saturation value of 0 to them. Each point source of light received from the laser devices (FIG. 3, reference character 36) will produce a high saturation value at each camera pixel (above 200) within each difference frame as a result of the point source moving relative to each NTSC frame. Solar reflections in the same pixel locations will cancel each other during the subtraction process. Another processing technique for discarding unwanted reflections is to observe the number of pixels illuminated by a reflection. If the bright spots are to large, they are attributed to reflections. It will be appreciated that many parallel processing steps are incorporated into the image processing stages within the image capture system. These processes are carried out over eight ˜4 ms subframes (2 NTSC frames) and are carried out in order to acquire the bright spots corresponding to the objects or targets being filmed. Once the objects have been acquired, each object's bright spot within the optically filtered image frames is processed in order to determine its coordinate position value.

In the case where the object is a moving car, at a distance of approximately 1200 feet, the image of the car moves across the pixel array of 512 pixels which generate the image frames in approximately one second. If four cars are being tracked, where each car emits an optical identification signal from an attached optical identifier device 12, then each optical identification signal is emitted from each car every four subframes or ˜16 ms. This corresponds to the car moving approximately 8 pixels from its last position in the previous NTSC frame (or 4 subframes before). Therefore, the coordinate position value for each bright spot corresponding to each car, only moves by a limited number of pixels between NTSC frames. If, for example, the coordinate position value of a bright spot should suddenly appear a considerable number of pixels away from the previously calculated coordinate position value, the bright spot may be discarded as a solar reflection and not a bright spot generated by the optical identification signal. Appropriate processing algorithms may be incorporated into the image processing stages to increase the accuracy with which the desired bright spots are acquired.

The image processed optically filtered image frames which contain bright spots corresponding to each object (e.g. race car) are received by a coordinate detector device 82. The coordinate detector device 82 is a component of the picture frame processing system 68. The coordinate detector device 82 determines the X (horizontal) and Y (vertical) coordinate position values of pixels saturated by bright spots generated by the optical identification signal emitted from each moving object (having an optical identifier device). For each moving object (e.g. race car) and during each 4 ms subframe within an NTSC frame, the coordinate detector device 82 determines the bright spot X (horizontal) and Y (vertical) coordinate position value. Based on the movement of the determined coordinate position values corresponding to the object's movement, the coordinate detector device 82 carries out further processing steps to ensure smooth movement of the detected coordinate position values between successive NTSC image frames. The coordinate detector device 82 generates an X coordinate position signal, indicated at 84, and a Y coordinate position signal, indicated at 86, wherein the X coordinate position signal corresponds to a running average of the X coordinate position values determined from each subframe, and the Y coordinate position signal corresponds to a running average of the Y coordinate position values determined from each subframe. Each subframe essentially is an optically filtered image frame received from the second camera device 64 and each subframe is processed within an NTSC frame.

To determine the running average, a series of initially determined X and Y coordinate values are averaged over several subframes (e.g. over 15 subframes) and each new determined X and Y coordinate value is averaged with respect to the averaged X and Y coordinate values (e.g. over 15 subframes). Hence, the X coordinate position signal, indicated at 84, and the Y coordinate position signal, indicated at 86, generate current coordinate position values with smoothed movement with respect to the moving object. This coordinate averaging process between subframes also provides a coordinate position value prediction scheme for predicting the next coordinate position value of the object. This is particularly useful in instances during which the optical identification signal cannot be processed during a subframe period.

The X and Y coordinate position signal is received by a picture-in-picture processor 88. The NTSC picture-in-picture processor 88 generates an NTSC picture-in-picture signal, as indicated at 90. The picture-in-picture processor 88 receives both an information graphic image, indicated at 92, and NTSC broadcast image frames, indicated at 94, from the broadcast camera 62 and generates the picture-in-picture signal, indicated at 90. The picture-in-picture signal, indicated at 90, is the superposition of the graphic image, indicated at 92, and NTSC broadcast image frames, indicated at 94. The picture-in-picture processor 88 superimposes the information graphic image onto the broadcast image frames at a location related to that indicated by the X coordinate position signal, indicated at 84, and the Y coordinate position signal, indicated at 86. As a result of the image capture system tracking the optical identification signal, the coordinate position value for each bright spot found in an optically filtered frame is always in the region of the optical identifier device 12. Therefore, the generated X and Y coordinate position signals, indicated at 84 and 86, will cause the graphic image to track the movement of the object for each NTSC frame. Furthermore, as the X and Y coordinate position signals, indicated at 84 and 86, are based on averaged (running average) coordinate position values of each bright spot (within the optically filtered frames), the graphic image will smoothly track the image of the moving object during the NTSC image frames. An example of the graphic image 28 is shown in FIG. 2.

The picture frame processing system 68 further includes a graphic insert generator 98 and an information data base 100. The image tracking system allows a graphic image insert containing information to track the movement of the image of the moving object. This information is specific to each object being tracked. For example, if four race cars are being tracked, then each car will have a graphic image with information regarding the driver and his or her performance. The displayed NTSC picture-in-picture signal, indicated at 90, will show a graphic image with inserted information, wherein the graphic image tracks a corresponding race car image across the display screen (e.g. TV screen).

In order to determine what information must be inserted within an object's graphic image, a unique identifier decoder device 102 decodes the unique identifier code modulated onto the optical identification signal emitted from each moving object. As previously discussed, each moving object (up to a maximum of four in the example described) emits an optical identification signal modulated with its own unique identifier code. Within each subframe, the unique identifier code is extracted from each optically filtered image frame, wherein the unique identifier code identifies which object has emitted the optical identifier signal. The extracted unique identifier code is received by the information database 100, which generates the statistics and necessary information related to the object having that unique identifier code. The statistics and necessary information generated by the database 100 are received by the graphic insert generator 98 and inserted within an information graphic image, which is received by the picture-in-picture processor 88. The picture-in-picture processor 88 superimposes the graphic image onto the NTSC image frame at a coordinate position close to the corresponding object to which the information is related. It will be appreciated however, that generating an information thumb nail graphic image for each object occurs within that object's designated subframe period ( ˜4 ms), and that the corresponding coordinates of this object for inserting the graphic image are also generated within this subframe. This applies for other objects being tracked.

FIG. 5 illustrates an alternative embodiment of the present invention, wherein the image capture system comprises a single lens imaging system. The operation of components 76A, 78A, 80A, 82A, 88A, 98A, 100A and 102A of the picture frame processing system 68A is identical to that of components 76, 78, 80, 82, 88, 98, 100 and 102 respectively of the picture frame processing system 68 illustrated in FIG. 4. The mechanical structure or arrangement of the first and second camera device 106, 108, is such that they share the same camera lens system 110. The camera lens 110 comprises an optical splitter 112, which receives a first and second optical signal, wherein the first optical signal is the image of the moving object and the second optical signal is the optical identification signal emitted from this moving object all combined as a single optical signal.

The optical splitter 112 directs the image of the moving object along a first optical path and directs the optical identification signal along a second optical path, wherein the first and second optical paths are orthogonal. The image of the moving object directed along the first optical path is received by a first camera 106 and the optical identification signal directed along the second optical path is received by the second camera 108 and then is additionally optically filtered by a narrowband optical filter 114. The difference between the two cameras is that one camera (first camera 106) generates a first series of image frames which include broadcast quality image frames of the moving object (or objects), whilst the other camera (second camera 108) generates a second series of image frames which include optically filtered image frames of the optical identification signal (or signals). The optically filtered image frames and broadcast quality image frames are processed within the picture frame processing system 68A in an identical manner to that described previously in relation to the picture frame processing system 68 of the embodiment of FIG. 4.

FIG. 6 illustrates the optical system within the single lens imaging system of FIG. 5. The optical system comprises the optical splitter 112 (a dichroic mirror), a first lens 116, a second lens 118, a first focusing lens 120 and a second focusing lens 122. The image of the moving object (or objects) and the optical identification signal (or signals) emitted from each moving object (maximum of four), as indicated at 124, are received by the first and second lens 116, 118. The separation of the first and second lens 116, 118 is selected to be equivalent to the sum of each lens focal length. In this lens configuration the received image of the moving object (or objects) and the optical identification signal (or signals) form a collimated beam which is incident on the dichroic beam splitter 112. The dichroic beam splitter 112 transmits the incident collimated image of the moving object (or objects) along the first optical path to the first focusing lens 120. The first focusing lens then focuses the collimated image of the moving object (or objects) onto the first camera 106, wherein the first camera 106 generates image frames of the moving object at the NTSC rate (60 frame/sec).

On the other hand, the dichroic beam splitter 112 reflects the wavelength of the collimated optical identification signal along the second optical path through the narrowband optical filter 114 to the second focusing lens 122. The second focusing lens 122 focuses the collimated optical identification signal onto the second camera 108, wherein the second camera 108 is a high frame rate camera (four times NTSC rate) which generates the optically filtered image frames of the optical identification signal. The optically filtered image frames and image frames of the moving object are processed by the picture frame processing system as explained previously.

In accordance with the present invention, the moving object is tracked whether it is stationary or moving and during both panning and zooming functions of the camera or cameras. The object may be a race car or a police car being tracked with a camera from the air. The applications of the invention are extended to tracking any object or vehicle having an optical identifier device and the coordinate position value can be used to initiate automated tracking of the vehicle or object.

It will also be appreciated that the present invention relates to any imaging system requiring the tracking of an object image. The invention is applicable to other broadcast standards such as PAL, SECAM or any other broadcast or imaging standard that may emerge in the future.

It should be understood that various modifications can be made to the preferred and alternative embodiments described and illustrated herein, the scope of which is defined in the appended claims.

I/we claim:

1. An image tracking apparatus for tracking the movement of an image of a corresponding moving object, the apparatus comprising:
(a) an optical identifier device which attaches to said moving object and generates an optical identification signal; and
(b) an image capture system for receiving said image of said moving object and said optical identification signal, and generating a coordinate position value related to said image of said moving object.

2. The image tracking apparatus as claimed in claim 1, wherein said image capture system comprises:
(a) a camera system for receiving said image of said moving object and said optical identification signal, and generating a first and second series of image frames; and
(b) a picture frame processing system for processing said second series of image frames and generating said coordinate position value related to said image of said moving object.

3. The image tracking apparatus as claimed in claim 2, wherein said camera system comprises:
(a) a first camera for receiving said image of said moving object and generating said first series of image frames; and
(b) a second camera for receiving said optical identification signal and generating said second series of image frames.

4. The image tracking apparatus as claimed in claim 3, wherein said first series of image frames include broadcast quality images of said moving object.

5. The image tracking apparatus as claimed in claim 4, wherein said second series of image frames include optically filtered image frames.

6. The image tracking apparatus as claimed in claim 5, wherein said second camera includes a narrow band optical filter which receives said image of said optical identification signal and generates said optically filtered image frames.

7. The image tracking apparatus as claimed in claim 6, wherein each of said optically filtered image frames include images of only said optical identification signal.

8. The image tracking apparatus as claimed in claim 7, wherein said picture frame processing system includes a coordinate detector, which receives said optically filtered image frames and generates an X and Y coordinate position signal for said optical identification signal within each of said optically filtered image frames.

9. The image tracking apparatus as claimed in claim 8, wherein said X coordinate position signal corresponds to a running average of X coordinate position values determined from each of said optically filtered image frames; and said Y coordinate position signal corresponds to a running average of Y coordinate position values within each of said optically filtered image frames.

10. The image tracking apparatus as claimed in claim 9, wherein said picture frame processing system further includes a decoder, said decoder receiving said optical identification signal within each of said optically filtered image frames and generating an electrical decoder signal.

11. The image tracking apparatus as claimed in claim 10, wherein said picture frame processing system includes a graphics generator, said graphics generator receiving said electrical decoder signal and generating a graphic image containing information associated with said image of said moving object.

12. The image tracking apparatus as claimed in claim 11, further comprising a picture-in-picture processor which receives both said X and Y coordinate position signal and generates said coordinate position value.

13. The image tracking apparatus as claimed in claim 12, wherein said picture-in-picture processor receives said broadcast quality images of said moving object and said graphic image, and superimposes said graphic image on said broadcast quality images of said moving object at a position related to said coordinate position value.

14. The image tracking apparatus as claimed in claim 13, wherein said optical identifier device comprises:
(a) a laser controller for generating an electrical drive signal, said electrical drive signal including a unique identifier code; and
(b) a plurality of laser devices, wherein said electrical drive signal including said unique identifier code modulates said laser devices and generates said optical identification signal.

15. The image tracking apparatus as claimed in claim 14, wherein said laser controller includes:
(b) a modulation controller device for receiving an enable signal and generating said electrical drive signal; and
(a) a synchronization device for generating said enable signal such that said electrical drive signal modulates said lasers in phase with said decoder device receiving said optical identification signal within each of said optically filtered image frames.

16. The image tracking apparatus as claimed in claim 2, wherein said camera system includes a camera device comprising:
(a) an optical splitter system for receiving said image of said moving object and said optical identification signal, and generating a first and second optical signal along a first and second orthogonal path;
(b) a first camera device positioned along said first orthogonal path to receive said first optical signal and generate said first series of image frames ; and
(c) a second camera device positioned along said second orthogonal path to receive said second optical signal and generate said second series of image frames.

17. The image tracking apparatus as claimed in claim 16, wherein said optical splitter system comprises:
(a) a lens system for receiving said image of said moving object and said optical identification signal and producing a collimated optical beam;
(b) an optical beam splitter for receiving said collimated optical beam and producing a first collimated optical output along said first orthogonal path; and producing a second collimated optical output along said second orthogonal path.

18. The image tracking apparatus as claimed in claim 17, further comprising a first and second focusing lens, wherein said first focusing lens receives said first collimated optical output and produces said first optical signal; and said second focusing lens receives said second collimated optical output and produces said second optical signal.

19. The image tracking apparatus as claimed in claim 18, wherein said first optical signal is said image of said moving object and said second optical signal is said optical identification signal.

20. The image tracking apparatus as claimed in claim 19, wherein said first series of image frames are image frames of said moving object; and said second series of image frames are optically filtered image frames of said optical identification signal.

21. The image tracking apparatus as claimed in claim 20, wherein said picture frame processing system includes a coordinate detector device, which receives said optically filtered image frames of said optical identification signal and generates an X and Y coordinate position signal for said optical identification signal within each of said optically filtered image frames.

22. The image tracking apparatus as claimed in claim 21, wherein said X coordinate position signal corresponds to a running average of X coordinate position values determined from each of said optically filtered image frames; and said Y coordinate position signal corresponds to a running average of Y coordinate position values within each of said optically filtered image frames.

23. The image tracking apparatus as claimed in claim 22, wherein said picture frame processing system further includes a decoder device, said decoder device receiving said optical identification signal within each of said optically filtered image frames of said optical identification signal and generating an electrical decoder signal.

24. The image tracking apparatus as claimed in claim 23, wherein said picture frame processing system includes a graphics generator, said graphics generator receiving said electrical decoder signal and generating a graphic image corresponding to said image of said moving object.

25. The image tracking apparatus as claimed in claim 24, further comprising a picture-in-picture processor which receives both said X and Y coordinate position signal and generates said coordinate position value.

26. The image tracking apparatus as claimed in claim 25, wherein said picture-in-picture processor receives said broadcast quality images of said moving object and said graphic image, and superimposes said graphic image on said broadcast quality images of said moving object at a position related to said coordinate position value.

27. A method of tracking the movement of an image of a corresponding moving object, the method comprising:
(a) generating an optical identification signal at said moving object, as said moving object moves; and
(b) receiving an image of said moving object and said optical identification signal, and generating a coordinate position value related to said image of said moving object.

28. The method as claimed in claim 27, wherein said coordinate position value provides an X and Y position coordinate corresponding to said optical identification signal.

29. The method as claimed in claim 28, including determining an insertion position utilizing said X and Y position coordinates and inserting an information graphic image at said insertion position.
